(19) United States
(12) Patent Application Publication
(10) Pub. No.: US 2017/0308137 A1
(43) Pub. Date: Oct. 26, 2017

(54) SYSTEM AND METHOD FOR RACK OVER PROVISIONING AND INTELLIGENT POWER MANAGEMENT

(71) Applicant: AVOCENT HUNTSVILLE, LLC, Huntsville, AL (US)

(72) Inventors: Henrique OLIVEIRA, San Ramon, CA (US); Steve JEHRING, Pleasanton, CA (US); Joerg WEEDERMANN, Santa Clara, CA (US); Donald A. STURGEON, Huntsville, AL (US)

(73) Assignee: AVOCENT HUNTSVILLE, LLC, Huntsville, AL (US)

(21) Appl. No.: 15/540,950

(22) PCT Filed: Aug. 11, 2015
(86) PCT No.: PCT/US2015/044668

§ 371 Date: Jun. 29, 2017

Related U.S. Application Data
(60) Provisional application No. 62/036,458, filed on Aug. 12, 2014.

(51) Int. Cl. G06F 1/26; G06F 1/32

(52) U.S. Cl. CPC G06F 1/263; G06F 1/3287; G06F 1/32; G06F 1/26

(57) ABSTRACT

The present disclosure relates to a method for managing an application of power from first and second power sources to a plurality of components mounted within an equipment rack. The method involves determining the number of components located within the equipment rack, and also determining a maximum power available from each of the first and second power sources. For each one of the components, first and second power budgets are determined. The first power budget represents an amount of power available to each one of the components when both of the first and second power sources are available for use, and the second power budget represents a power available to each when only the second power source is available for use. The method enables using a portion of power available from each of the first and second power sources to power the plurality of components, and using a rack management system to receive the first and second power budgets, and to apply the second power budget when a power loss condition causes the first power source to become unavailable.

### CROSS-REFERENCE TO RELATED APPLICATIONS

This application is a PCT International Application of U.S. Patent Application No. 62/036,458 filed on Aug. 12, 2014. The entire disclosure of the above application is incorporated herein by reference.

### FIELD

The present disclosure relates generally to power management systems used in data center applications, and more particularly to a system and method for power management that utilizes two redundant power sources to continuously power a greater number of components than what would be possible without this system. This power management system implements an intelligent power consumption control protocol or scheme such that in the event that power from one of the two redundant power sources is lost, all of the components are still powered but at a reduced utilization percentage.

### BACKGROUND

A challenge with modern day data centers can be explained with looking at just a single equipment rack that has a plurality of servers mounted in it. Thus, consider an equipment rack having, for example, 16 shelves supporting 16 servers, which represents the maximum number of servers that may be supported within the rack. An example of this is shown in FIG. 1. At the present time, a standard rack will traditionally have two redundant power sources, which are allocated in such a way that each is sufficient to power all 16 servers. So for example, if each server draws 390 W at 100% utilization, each power source needs to be able to provide 6240 W (390 W×16) to be able to power all 16 servers when all 16 servers are operating at 100% utilization. Thus, when a rack has redundant power sources where each is able to provide full power to all the servers while each server is operating at 100% utilization, then the combined amount of power capacity delivered by both power sources is double what the rack needs. Racks have traditionally been configured this way because both power sources need to be able to power all of the servers in the rack, while each server is operating at 100% utilization, when power from one of the power sources is lost. This is shown in FIG. 2 where one power source is supplying the full 6240 W to the servers in the rack. However, configuring an equipment rack like this means that, during most times, each rack will have available to it basically twice the power that the rack needs, even when all 16 servers in the rack are operating at 100% utilization.

It is also important to note in the example above that during any given time period, not every server housed in the rack will be operating at 100% utilization. Experience may indicate that each server may typically run for most of the day at 80% utilization, with a few brief periods where utilization spikes close to, or at, 100%. Moreover, it is typically rare for all the servers in a given rack to spike close to 100% utilization at the same time. So the much more typical condition is that most of the servers will be operating throughout the day at some reduced utilization, for example 80%, with the utilization of various ones of the servers temporarily increasing to close to 100% (or to 100%) at different times, but for relatively brief time periods. The result is that a fair amount of power is being stranded at the rack. By “stranded” it is meant that quantity of power that is available to the rack but which is not used by the equipment in the rack at a given time. In this example, the stranded power results because the full output of the power associated with each rack (in this example a full 6240 W) is only used if one of the power circuits is lost. And then even if one of the power circuits is lost, it would be a rare condition if all of the servers in the rack were operating at 100% utilization and requiring the full 6240 W output of the backup power source.

The traditional way of provisioning each rack with sufficient power in each redundant power circuit to power all of the components of the rack, as described above, introduces significant additional cost in the setup of a data center. This is because of the need to provision each and every rack of the data center with two power circuits, each having sufficient capacity to power all of the components of the rack at 100% utilization.

### SUMMARY

This section provides a general summary of the disclosure, and is not a comprehensive disclosure of its full scope or all of its features. In one aspect the present disclosure relates to a method for managing an application of power from first and second power sources to a plurality of components mounted within an equipment rack. The method may comprise determining a number of components located within the equipment rack, and also determining a maximum power available from each of the first and second power sources. The method may further include determining, for each one of the components, a first power budget and a second power budget. The first power budget represents an amount of power available to each one of the components when both of the first and second power sources are available for use, and the second power budget represents an amount of power available to each one of the components when only the second power source is available for use. The method may further include using a rack management system to perform a plurality of operations including at least one of: to monitor incoming power or receive information on incoming power from first and second power sources, wherein the incoming power is available for use by the plurality of components; to apply the first power budget when both of the first and second power sources are available and supplying power to the plurality of components; to determine when a disruption in power from one of the first or second power sources being used by the plurality of devices has occurred; and when the disruption in power occurs, to apply the second power budget. In another aspect the present disclosure relates to a method for managing an application of power from first and second power sources to a plurality of components mounted within an equipment rack. The method may comprise determining a number of components located within the equipment rack, and determining a maximum power available from each of the first and second power sources. The method may further involve determining, for each one of the components, a first power budget and a second power budget. The first power budget represents an amount of power available to each one of the components when both of the first and second power sources are available for use. The second power budget represents a power available to each one of the components when only the second power source is available for use. The method further involves using a rack management system to receive the number of components and the maximum power available to a rack management system, and to determine when a power loss condition arises wherein the first power source becomes unavailable, while the second power source is still available. The method further involves using the rack management system to determine an at least substantially real time power utilization for each one of the components when the power loss condition arises, and to control a power level applied by the second power source. The power level applied by the second power source is controlled by the rack management system such that each one of the components is provided with a power level in accordance with the second power budget.

In still another aspect the present disclosure relates to a system for managing an application of power from first and second power sources to a plurality of components mounted within an equipment rack. The system may comprise a processor controlled rack management control system which may be positioned in the equipment rack, and in communication with each of the components in the equipment rack, and which receives information on a maximum power available from each of the first and second power sources. The rack management system is also configured to implement, for each one of the components, a first power budget and a second power budget. The first power budget represents an amount of power available to each one of the components when both of the first and second power sources are available for use. The second power budget represents a power available to each one of the components when only the second power source is available for use. The rack management system operates to apply the first power budget when both of the first and second power sources are active and jointly providing power to all of the plurality of components, and to apply the second power budget when the first power source suffers a power loss condition, which leaves only the second power source available to power the plurality of components.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a high level illustration of one example of a prior art rack having 16 shelves holding 16 servers, where the total combined power capacity from power sources A and B available to the rack is 12,480 W (2×6240 W), but where the two power sources A and B combined are only delivering 6240 W to the rack (i.e., only about 50% of the power available from each of the power sources A and B is being used by the equipment in the rack);

FIG. 2 is a high level illustration of the prior art rack of FIG. 1, but where power source A has stopped supplying power to the rack, and the remaining power source B is being used to provide full power to the 16 servers mounted in the rack;

FIG. 3 is a high level illustration of one example of how the system and method of the present disclosure may be implemented to make simultaneous use of both power sources A and B to power a greater number of components from the same power capacity (in this example a 6240W power supply acting as power source A and a 6240 W power supply acting as power source B), while powering 20 servers instead of the 16 servers shown in FIGS. 1 and 2;

FIG. 4 is an example to show how the full output of the power source B (e.g., 6240 W) may be used to power all 20 servers of the rack when power from power source A is lost, by intelligently capping power to each server at a maximum of 312 W per server;

FIG. 5 is a high level block diagram to illustrate one embodiment of a system in accordance with the present disclosure to implement power monitoring and intelligent power capping; and

FIG. 6 is a high level flowchart illustrating various operations that may be performed separately by a Rack Management System and by a server, to implement the power monitoring and intelligent power capping.

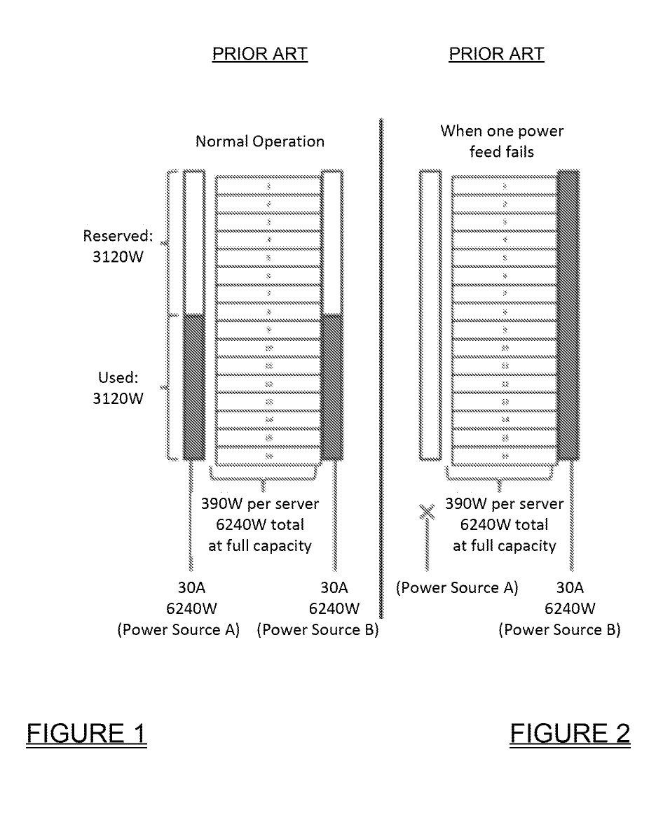

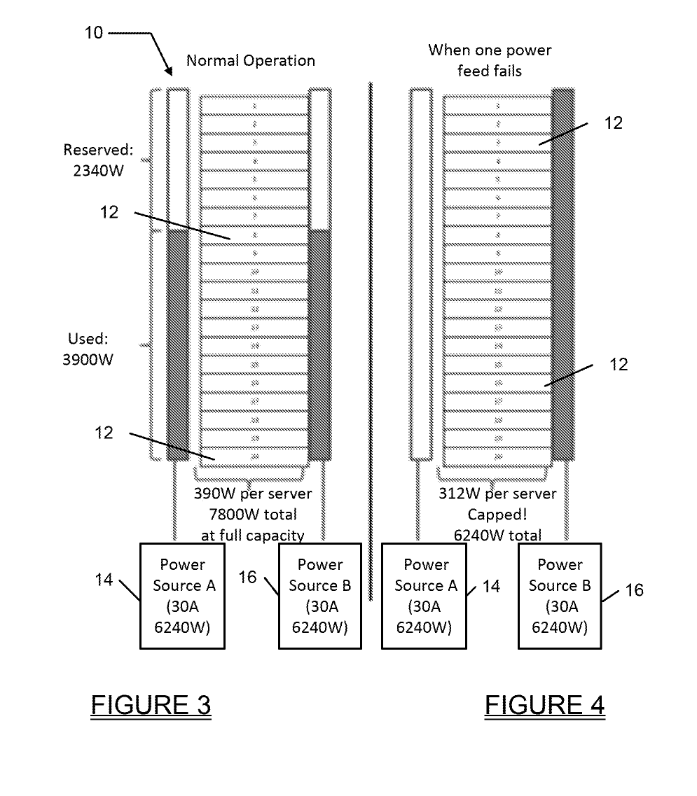

### DETAILED DESCRIPTION

The following description is merely exemplary in nature and is not intended to limit the present disclosure, application, or uses. It should be understood that throughout the drawings, corresponding reference numerals indicate like or corresponding parts and features. The terms “power capping” and “power mapping” may be used interchangeably throughout the following discussion.

In FIG. 3 an equipment rack 10 is shown in accordance with one embodiment of the present disclosure. In this example the devices will be described as servers, 12₁-12₂₀ although they need not be servers and may be virtually any type of computing and/or network device, or various combinations of servers, switches, computing devices and network devices.

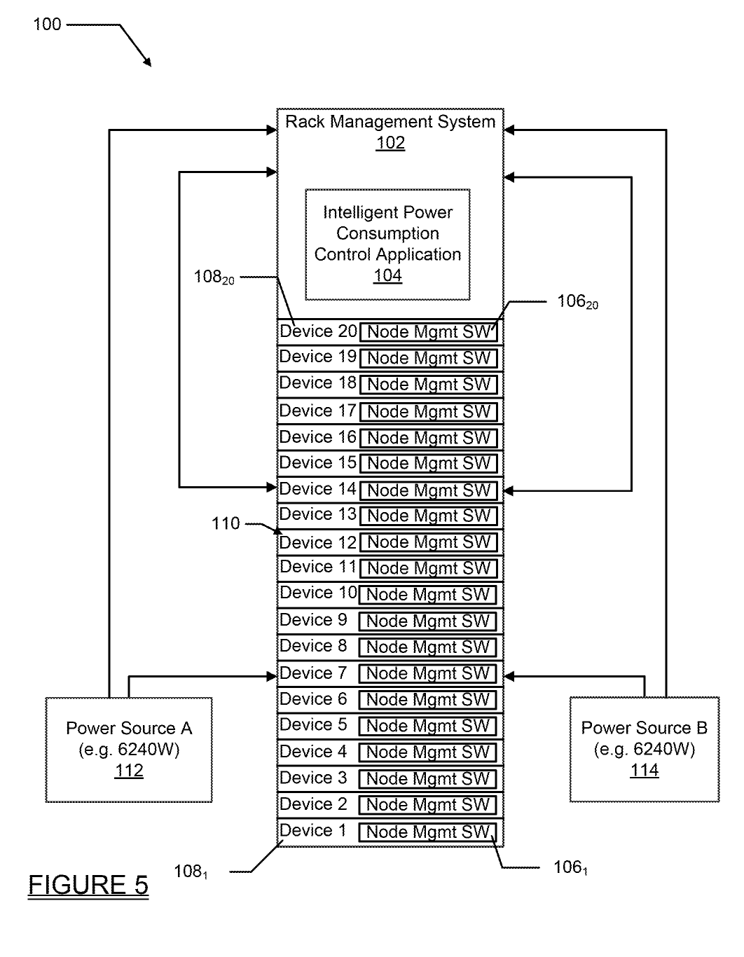

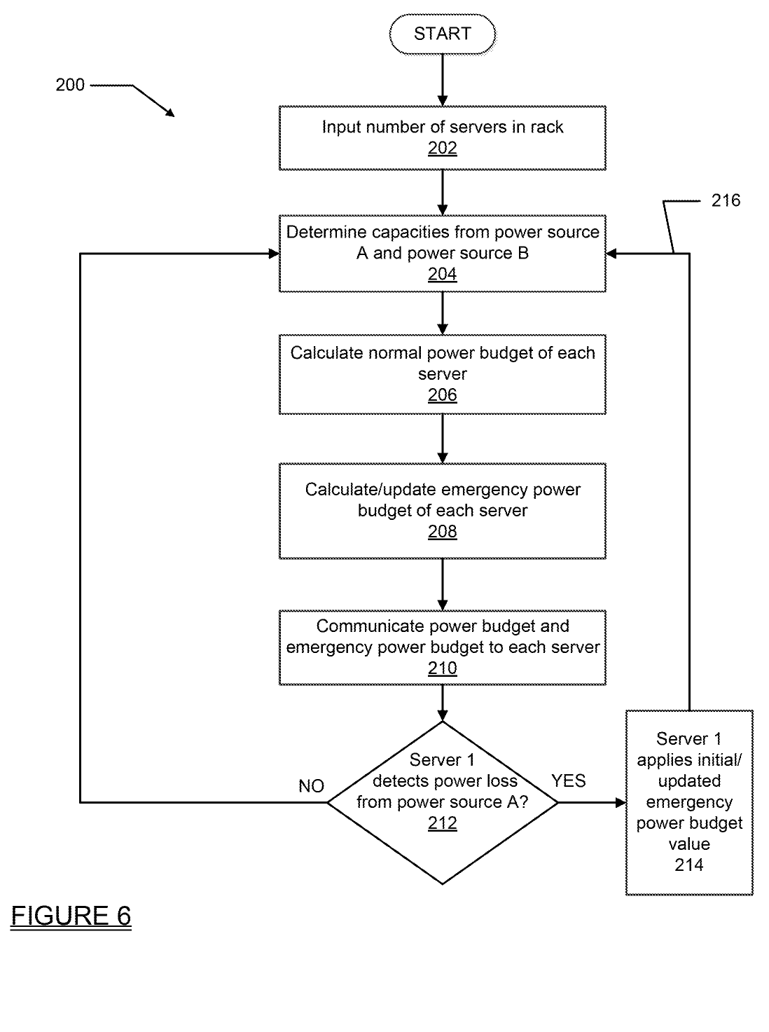

In FIG. 3, a power source A (labeled 14) is capable of supplying 6240 W. Likewise, another power source B (labeled 16) is provided which is capable of providing 6240 W. When both power sources A and B are active, each one of all 20 servers 12₁-12₂₀ can operate at 100% capacity, consuming 390 W. Thus all 20 servers consume a total of 7800 W, 3900 W from each of the two power sources A and B. In the example of FIG. 4, one of the power sources A or B is no longer active and the total power capacity available to the equipment rack 10 is 6240 W. The new, reduced maximum power draw for each of the 20 servers 12₁-12₂₀ is therefore 312 W. The reduced utilization is implemented through an intelligent power consumption control system, to be discussed momentarily in connection with FIG. 5. In actual practice, however, a more typical situation would be that certain ones of the servers 12₁-12₂₀ are operating somewhat above 312 W utilization at any given time while other ones of the servers in the equipment rack 10 will be operating at or below 312 W utilization, but that the overall average power consumption for all the servers may be about 312 W per server.

Referring to FIG. 5, one specific example of a power management system 100 is shown that employs the above-mentioned intelligent power consumption control methodology. In this example a rack management system 102 has an intelligent power consumption control application 104 running thereon. However, it will be appreciated immediately that the intelligent power consumption control application 104 may instead be integrated into a data center infrastructure management (DCIM) system, or it could be embedded in each component mounted in the rack, or possibly installed on a laptop or other personal computing device. The implementation of the intelligent power consumption control application 104 is not limited to any one specific implementation, and those skilled in the art will appreciate that other implementations may be possible as well as those mentioned above.

In FIG. 5 the rack management system 102 is shown in communication with node management software modules 106₁-106₂₀ installed on the 20 servers 108₁-108₂₀ respectively mounted within an equipment rack 110, and with both of power source A 112 and power source B 114 being used to power the components of the equipment rack 110. In this example, based on information gathered from each node management software module 106, from both power sources A and B, and potentially from other sources of information within a datacenter, the rack management system 102 is continuously calculating a first power budget and a second power budget, for each server 108₁-108₂₀ (to be discussed in greater detail later herein). The two power budgets may also be thought of as a “primary” power budget and an “emergency” power budget, with the emergency power budget being the power budget that is used in the event one of the power sources A or B becomes unavailable, and the primary power budget being used when both power sources A and B are available. Both of these power budget values are continuously communicated to each one of the 20 node management software modules 106₁-106₂₀. Although only one equipment rack 110 is shown in FIG. 5, it will be appreciated that in practice typically a plurality of equipment racks will be present, and in some instances dozens, hundreds or even thousands of such equipment racks, with each such equipment rack having its own rack management system 102.

With the system 100 shown in FIG. 5, the node power management software modules 106₁-106₂₀ in the servers 108₁-108₂₀ communicate with the rack management system 102, and more particularly with the intelligent power consumption control application 104. Each node power management software module 106₁-106₂₀ controls the power consumption of the particular server 108₁-108₂₀ it is running on. Each node management software module 106₁-106₂₀ receives the server power budget and the emergency power budget from the rack management system 102 on a continuous basis (i.e., updated repeatedly, for example every 10 ms-50 ms, in real time).

During operation while power source A and power source B are both available and each is capable of supplying the full 6240 W of power, the rack management system 102 is monitoring the total power consumption of the rack 110 by communicating with power sources A and B (112 and 114, respectively). The rack management system 102 is continuously calculating, essentially in real time, the power budget and the emergency power budget for each server 108₁-108₂₀. During this time all 20 of the servers 108₁-108₂₀ are being powered by equal amounts of power provided by power sources A and B. In this example that amounts to about 390 W for each server 108₁-108₂₀. A substantial amount of reserve power is still available, which in this example is about 2340 W (i.e., 6240 W−3900 W) from each power source A and B.

If one of the power sources A or B is lost, then the node management software module 106₁-106₂₀ in each server 108₁-108₂₀ detects that one power source is no longer available, and will virtually immediately (i.e., essentially in real time) limit the power draw of its associated server to its emergency power budget value, which was provided to it by the rack management system 102, and which in this particular example is 312 W (i.e., 6240 W total from the remaining power supply divided by 20 servers total=312 W per server). This enables all of the 20 servers 108₁-108₂₀ to be powered by only the one remaining power source. A significant advantage here is that because of the virtually immediately implemented power limiting (i.e., power capping) performed by each of the 20 servers, all 20 of the servers will remain powered. Thus, a greater number of servers (i.e., 20 as compared to 16 in a conventional implementation without power capping) can be powered both during times when power is available from both power sources A and B, as well as during times when power is lost from one of the power sources A and B. Referring briefly to FIG. 6, a flowchart 200 is shown providing one high level example of various operations that may be performed by the system 100 in monitoring and intelligently controlling the power consumption of the servers 108₁-108₂₀. It will be appreciated that the operations shown in FIG. 6 are repeated for however many different servers and equipment racks are being monitored by the system 100. Also, it will be appreciated that while the operations shown in FIG. 6 have been shown in a single flowchart, operations 202-210 typically may be performed by the rack management system 102 while operations 212 and 214 will be performed independently and asynchronously by each of the servers 108₁-108₂₀. However, the flowchart 200 is intended to provide just one example as to how the methodology underlying the system 100 may be implemented, and other specific implementations of the underlying methodology of the present disclosure are possible.

At operation 202 the number of servers for the given equipment rack is determined by either manual user input or by an automatic discovery system (not shown). At operation 204 the maximum power available from both power sources A and B will be determined. This determination may take into account information obtained from the power sources A and B themselves, by information obtained by other external systems, or by user input.

At operations 206 and 208 the rack management system 102 calculates the primary power budget and the emergency power budget that will be used for the servers 108₁-108₂₀. The primary power budget is defined as the total power capacity available to the servers 108₁-108₂₀ when both power sources A and B are operational. The emergency power budget is defined as the total power capacity available to the servers 108₁-108₂₀ when only one of the power sources A or B is operational. At operation 210, the primary power budget and the emergency power budget are communicated to each one of the node management software modules 106₁-106₂₀ associated with the servers 108₁-108₂₀ in the equipment rack 110.

Operations 212 and 214 are typically performed by each of the servers 108₁-108₂₀ asynchronously (i.e., independently of the rack management system 102). At operation 212, in this example server 1 (component 108₁) detects a power loss from power source A. At operation 214 server 1 applies the initial emergency power budget value that has been assigned to it by the rack management system 102. In this example the initial emergency power budget value is 312 W, which corresponds to 80% utilization of server 1. Server 1 reports this value back to the rack management system 102 as indicated by line 216. In actual practice the rack management system 102 may be constantly updating/re-determining the emergency power budget assigned to each of the 20 servers 108₁-108₂₀ in the equipment rack 110 based on real time utilization information received from each of the servers.

As another example, it may be that when the primary power source A is first lost, each of the servers 108₁-108₂₀ may be assigned an initial power budget of 312 W by the rack management system 102. But virtually immediately thereafter, servers 1-5 may report to the rack management system 102 that just prior to the power loss condition occurring, they were only operating at 60% utilization (thus consuming only 234 W), while servers 19 and 20 report that they were running at 90% utilization (i.e., which will require 351 W each) while servers 6-18 report that they were running at or below 80% utilization (i.e., requiring 312 W or less of power). Alternatively, this information may have been obtained by the rack management system 102 as part of its continuous real time monitoring of the utilizations of the servers 108₁-108₂₀. The rack management system 102 may determine that sufficient emergency power is available from the power source B to provide each of servers 19 and 20 with 351 W each, to thus allow each to continue operating at 90% utilization, while still meeting the needs of all of the other servers. The rack management system 102 then updates its real time power mapping to account for the 351 W being mapped to each of servers 19 and 20, as well as the 312 W (or less) being mapped to each of servers 6-18, and the 234 W being mapped to each of servers 1-5. The power requests from each of the servers 108₁-108₂₀ are continuously monitored by the rack management system 102 in real time, and the power that is mapped to each server 108₁-108₂₀ may be continuously adjusted, in real time, in an attempt to meet the power needs of each of the servers while still remaining within the 6240 W emergency power budget provided by the power source B.

The above power mapping methodology attempts to map power to each of the servers in a manner that provides each server with sufficient power to maintain at least 80% utilization (i.e., 312 W in this example) when one of the power sources A or B is lost. So, for example, if power is lost from one of power sources A or B and servers 1-3 had been operating at 75% utilization each (i.e., drawing 292.5 W each), servers 4-17 had been operating at 80% utilization each (i.e., drawing 312 W each), and servers 18-20 had been operating at 95% utilization each (i.e., drawing 370.5 W each), the rack management system 102 may map power such that only servers 18-20 have their power allocations reduced. So in this example, servers 1-3 would be using 877.5 W total (292.5 W each) and would not have their power draws reduced. Servers 4-17 would be using 4368 W total (312 W each) and likewise would not have their power draws reduced. And 994.5 W would be left available for servers 18-20 (6240 W—(4368+877.5)). So the available 994.5 W would be mapped equally between servers 18-20 (331.5 W each), which would allow each to run at 85% utilization in this example.

The above power mapping methodology may also include designating one or more of the servers 108₁-108₂₀ as having priority over other ones of the servers so that power to these designated servers is not capped. As such, these designated ones of the servers may be provided with 390 W of power from power source B when power source A is lost, while the other ones of the servers 108₁-108₂₀ are power capped as needed to maintain the collective power draw from power source B at a maximum of 6240 watts. A “hierarchy” of priorities could also be used where one or more servers is assigned a first priority level, a second group of one or more servers is assigned a second priority level, and so forth, and the power mapping implemented by the system 100 maps power to the servers 108₁-108₂₀ in accordance with the predetermined priority levels. So for this example, assuming that the second priority level indicates a greater importance than the third priority level, and the first priority level indicates a greater importance than the second priority level, the power capping would be implemented by capping power to those servers in the third group first, in an attempt to reduce the overall power draw by all of the servers to 6240 W. If that cannot be accomplished, then power will be capped to the servers of group two as needed as well, and lastly to those servers of group one.

The system 100 thus allows a significant increase in utilization of datacenter infrastructure to be achieved with minimal, or no, reduction in the CPU performance of each of the servers 108₁-108₂₀. The system 100 and its intelligent power control enables full power (390 W) to be delivered to each of the 20 servers 108₁-108₂₀ in this example. Advantageously, during normal operation all 20 servers 108₁-108₂₀ are provided with full power (i.e., 390 W). In other words, no additional power capacity that is not already present and supporting the rack 110 needs to be added. When power loss from one of the power sources A or B occurs, intelligent power mapping is implemented in real time to maintain all of the 20 servers 108₁-108₂₀ operational, but at a reduced utilization percentage which does not overload the remaining power source.

The system 100 thus enables a greater number of servers located within a single equipment rack to be powered, with two given power sources, than would otherwise be possible without the intelligent power consumption control that the system 100 provides. In practice, this is not expected to introduce any significant performance degradation, at least for relatively short periods of time, because of the recognition that most servers in a data center will not be running at 100% utilization. Instead, most servers run at something less than 100% utilization for most times during any given day, and typically only occasionally at 100% or close to 100% for brief periods of time.

The system 100 also reduces the amount of backup power that needs to be provisioned for each equipment rack. The teachings of the present disclosure can be extended to applications where greater or lesser numbers of computing or network devices are housed in an equipment rack, and the present disclosure is therefore not limited to only implementations where 20 servers or network components are housed in each equipment rack. With the growing size of modern day data centers, one will appreciate the significant cost savings that may be realized using the system 100. The savings is expected to increase as the size of the data center increases. With many modern large scale data centers employing hundreds or even thousands of equipment racks, it will be appreciated that the cost savings that may be realized using the system 100 may be significant.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

1. A method for managing an application of power from first and second power sources to a plurality of components mounted within an equipment rack, wherein neither of the first and second power sources has a sufficient total power capacity to power all of the components mounted within the equipment rack, simultaneously, at maximum power utilization levels of the components, the method comprising:
determining a number of the plurality of components located within the equipment rack;
determining a maximum power available from each of the first and second power sources;
determining, for each one of the plurality of components, a first power budget and a second power budget;
the first power budget representing an amount of power available to each one of the plurality of components when both of the first and second power sources are available for use, and the first power budget enabling sufficient power to be provided to each of the components to allow all of the components to be operated simultaneously at said maximum power utilization levels;
the second power budget representing an amount of power available to each one of the plurality of components when only the second power source is available for use, and wherein the second power budget is insufficient to power each of the components simultaneously at said maximum power utilization levels;
using a portion of power available from each of the first and second power sources to power the plurality of components; and
using a rack management system to:
at least one of monitor incoming power or receive information on incoming power from first and second power sources, which said incoming power is available for use by the plurality of components;
apply the first power budget when both of the first and second power sources are available and supplying power to the plurality of components;
determine when a disruption in power from one of the first or second power sources being used by the plurality of devices has occurred; and
when the disruption in power occurs, apply the second power budget.

2. The method of claim 1, wherein rack management system initially applies specific amounts of power, in accordance with the second power budget, to each one of the plurality of components when the power loss condition occurs, and then modifies the second power budget in substantially real time according to information received regarding a real time utilization of each one of the plurality of components.

3. The method of claim 1, wherein said second power budget represents a priority scheme which is applied to control the amount of power available to the plurality of components such that a certain one or more of the plurality of components has, or have, priority over other ones of the plurality of components to access remaining available power from the second power source.

4. A method for managing an application of power from first and second power sources to a plurality of components mounted within an equipment rack, wherein neither of the first and second power sources has a sufficient total power capacity to power each one of the plurality of components mounted within the equipment rack, simultaneously, at maximum power utilization levels for the plurality of components, the method comprising:
determining a number of the plurality of components located within the equipment rack;
determining a maximum r available from each of the first and second power sources;
determining, for each one of he plurality of components, a first power budget and a second power budget,
the first power budget representing an amount of power available to each one of the plurality of components when both of the first and second, power sources are available for use, the first power budget further enabling sufficient power to be provided to each one of the plurality of components to allow all of the plurality of components to be operated simultaneously at said maximum power utilization levels;
and the second power budget representing a power available to each one of the plurality of components when only the second power source is available for use, and wherein the second power budget is insufficient to power each one of the plurality of components simultaneously at said maximum power utilization levels;
using a rack management system to:
receive inputs on the number of components and the maximum power available to a rack management system;
determine when a power loss condition arises wherein the first power source becomes unavailable, while the second power source is still available; determine a substantially real time power utilization for each one of the plurality of components when the power loss condition arises; and
control a power level applied by the second power source such that each one of the plurality of components is provided with a power level in accordance with the second power budget.

5. The method of claim 4, further comprising using the rack management system to continue to receive information on the power utilization of each one of the plurality of components after the power loss condition arises; and
causing the rack management system to alter the second power budget such that the level of power being provided to at least two of the plurality of components is different, and without exceeding the power available from the second power source.

6. The method of claim 5, wherein the rack management system assigns different levels of power to the at least two components based on a predetermined priority scheme for the plurality of components, and without exceeding the power available from the second power source.

7. The method of claim 4, wherein the second power budget represents a level of power to be applied to each of the components which is sufficient to enable each one of the plurality of components to operate at a predetermined minimum utilization level; and
when at least one of the plurality of components is operating at an actual utilization level below the predetermined minimum utilization level after the power loss condition occurs, the rack management system further alters the second power budget to modify a level of power available to at least one other one of the plurality of components to allow the one other one of the plurality of components to draw an adjusted power level which exceeds an amount initially allocated to it by the second power budget, and further such that power being drawn by all of the plurality of components still does not exceed the power available from the second power source.

8. The method of claim 4, wherein the rack management system receives substantially real time utilization information from at least a subplurality of the plurality of components after the power loss condition occurs, and continuously updates available power assigned to each one of the plurality of components.

9. The method of claim 4, wherein:
the second power budget allows a first subplurality of the plurality of components to be provided with an initial power level that may be exceeded depending upon a utilization of each one of the first subplurality of the plurality of components; and
a second subplurality of the plurality of components is provided with a power level that is capped and which cannot be exceeded.

10. The method of claim 4, wherein at least one of the plurality of components is assigned an initial power level in the second power budget that cannot be reduced.

11. The method of claim 4, further comprising using a plurality of node management modules associated independently with each of the plurality of components to report substantially real time utilization of each one of the plurality of components.

12. The method of claim 4, wherein the second power budget allocates first, second and third priority levels to each of the components, wherein the second priority level is higher than the third priority level, and wherein the first priority level is higher than the second priority level, and wherein the rack management system assigns power levels to each one of the plurality of components in accordance with their respective said priority levels.

13. The method of claim 4, wherein when both of the first and second power sources are available, and the first power budget is being implemented, a total power consumed by the plurality of components exceeds the power available from either one of the second power source or the first power source.

14. The method of claim 4, wherein:
at least a first one of the plurality of components is allowed to draw more power than an initially set power level provided in the second power budget; and
at least a second one of the plurality of components has its assigned power level reduced below its initially set power level while the first one of the plurality of components is drawing more power than its initially set power level.

15. A system for managing an application of power from first and second power sources to a plurality of components mounted within an equipment rack, wherein neither of the first and second power sources has a sufficient total power capacity to power all of the components mounted within the equipment rack, simultaneously, at maximum power utilization levels of the components, the system comprising:
a processor controlled rack management control system configured to:
be mounted within the equipment rack and to communicate with each one of the plurality of components located within the equipment rack;
at least one of determine, or receive information concerning, a maximum power available from each of the first and second power sources;
implement, for each one of the components, a first power budget and a second power budget,
the first power budget representing an amount of power available to each one of the plurality of components when both of the first and second power sources are available for use, and the first power budget further enabling sufficient power to be provided to each of the components to allow all of the components to be operated simultaneously at said maximum power utilization levels;
the second power budget representing a power available to each one of the plurality of components when only the second power source is available for use;
apply the first power budget when both of the first and second power sources are active and jointly providing power to all of the plurality of components; and
apply the second power budget when the first power source suffers a power loss condition, which leaves only the second power source available to power the plurality of components.

16. The system of claim 15, wherein the rack management system uses the second power budget to initially apply specific amounts of power to each of one of the plurality of components when the power loss condition occurs, and modifies the second power budget in substantially real time according to information received regarding a utilization of each one of the plurality of components.

17. The system of claim 15, wherein the rack management system uses the second power budget to implement a priority scheme to control each one of the plurality of components such that a certain one or more of the plurality of components has, or have, priority over other ones of the plurality of components, to access available remaining power from the second power source.

18. The system of claim 15, wherein the rack management system is operable to continue to receive substantially real time information on the power utilization of each one of the plurality of components after the power loss condition arises; and
wherein the rack management system is operable to alter the second power budget such that the level of power being provided to at least two of the plurality of components is different, and without exceeding the power available from the second power source.

19. The system of claim 15, further comprising a plurality of node management modules associated independently with each of the plurality of components to report substantially real time utilization of each one of the plurality of components to the rack management system.
